(19) United States
(12) Patent Application Publication
(10) Pub. No.: US 2005/0190335 A1
(43) Pub. Date: Sep. 1, 2005

(54) Liquid crystal display device having an injection hole for liquid crystal

(75) Inventors: Muneo Maruyama, Kawasaki (JP); Masaki Satoh, Akita-shi (JP)

Correspondence Address: Norman P. Soloway;HAYES SOLOWAY PC, 130 W. Cushing Street, Tucson, AZ, 85701, US

(73) Assignee: NEC LCD Technologies, Ltd.

(21) Appl. No.: 11/065,991

(22) Filed: Feb. 24, 2005

(30) Foreign Application Priority Data
Feb. 27, 2004 (JP) 2004-053453

(51) Int. Cl. G02F 1/1339

(52) U.S. Cl. 349/153

(57) ABSTRACT

An LCD device includes a pair of transparent substrates bonded together by a seal resin stripe to sandwich therebetween a liquid crystal layer. The seal resin stripe has therein an injection hole plugged with UV-cured resin for sealing the liquid crystal. A dummy wire is provided having a first portion underlying the seal resin stripe and a second portion underlying the UV-cured resin, both portions having a thickness equal to that of gate lines for achieving a uniform gap between the transparent substrates. The second portion is of a comb shape for passing therethrough UV-rays for curing the UV-curable resin to obtain well cured resin, which will not enter the liquid crystal layer.

### BACKGROUND OF THE INVENTION

1. Field of the Invention

The present invention relates to a liquid crystal display device having an injection hole for liquid crystal, and more particularly, to a technique to prevent deterioration of the image quality of a liquid crystal display device in the vicinity of the injection hole for liquid crystal.

2. Description of Related Art

A liquid crystal display (LCD) device has a pair of opposing glass substrates and a liquid crystal layer sandwiched therebetween. In the LCD device, a voltage is applied to the liquid crystal layer to control transmitted light, thereby displaying images. In manufacture of the LCD device, the glass substrates are bonded together by means of a seal resin stripe arranged on the periphery thereof. Liquid crystal is then injected into the space between the glass substrates through a liquid crystal injection hole penetrating the seal resin stripe, to be encapsulated in the space. Thereafter, the injection hole is plugged and sealed with a hole-sealing member made of UV-cured resin that has undergone ultraviolet exposure.

When bonding together the glass substrates, curing the UV-cured resin and injecting liquid crystal, it is noted that portions of the glass substrates in the vicinity of the injection hole are subject to a strain due to the pressure applied to the injection hole, involving a cell gap irregularity between the injection hole and the vicinity of the injection hole. The cell gap irregularity causes a change of brightness and/or chromaticity in the vicinity of the injection hole, which deteriorates the image quality of the LCD device.

In order to suppress or remove the cell gap irregularity in the vicinity of the injection hole, Patent Publication JP-A-2000-206546 describes an LCD device in which a columnar buffering seal or a dummy seal member which has a thickness equivalent to the thickness of the seal resin stripe is provided within the injection hole. Another Patent Publication JP-A-10(1998)-73830 describes an STN (Super-Twisted Nematic) LCD device of simple matrix drive type in which a transparent electrode extends within the injection hole, and a buffering seal member which has a thickness equivalent to the thickness of the seal resin stripe is arranged on the extending transparent electrode.

In general, an LCD device of active matrix drive type has a cell gap difference corresponding to the thickness of interconnections between the edges of the LCD panel through which interconnections such as scanning lines or data lines extend and other edges of the LCD panel. In recent years, the cell gap is significantly reduced along with the increase in the operational speed of the LCD device. On the other hand, along with a decrease in the thickness of the liquid crystal (LC) layer, unevenness in the brightness increases due to the cell gap difference, which raises the difficulty in maintaining an excellent image quality. In order to obtain the excellent image quality by adjusting the thickness of the edges of the LCD panel, the present inventors propose that the LCD device include a dummy wire in the peripheral area of the LCD device in which interconnections do not extend. The dummy wire is made of a material same as the material of the interconnections and extends on the seal resin stripe.

In the LCD device of active-matrix drive type, interconnections are formed from a metallic film, which is different from the transparent interconnections used in an LCD device of simple matrix drive type in which interconnections are made of a transparent material such as ITO (Indium Tin Oxide). As a result, in the injection hole, if dummy wire having a shape similar to the shape of the buffering seal member overlaps the buffering seal member, the dummy wire block the ultraviolet rays to thereby prevent the ultraviolet rays from curing the UV-curable resin. In this case, the amount of ultraviolet rays exposed to the inner side of the injection hole becomes insufficient, whereby uncured resin enters the LC layer through the inner side of the injection hole, thereby deteriorating the image quality of the LCD device.

On the other hand, if the dummy wire is not arranged in the injection hole, the problem of uncured resin is solved, whereas there remains an increased cell gap irregularity corresponding to the thickness of the dummy wire between the injection hole and the vicinity of the injection hole. According to researches by the present inventor, in a specific LCD device having an extremely thin LIC layer, the cell gap irregularity causes a change of the image quality and chromaticity in the vicinity of the injection hole, thereby deteriorating the image quality of the LCD device. The reason is that, for the LCD device having a thin LC layer, even if the cell gap irregularity itself is of a reasonable degree, the reasonable cell gap irregularity itself is not negligible relative to the thickness of the liquid crystal layer. In this case, deterioration of image quality in the vicinity of the injection hole is raised if the thickness of the LC layer is 4 μm or smaller, and causes a significant problem if the thickness is 3.3 μm or smaller. In the case of a general LCD device having a nematic LC layer, the lower limit of the thickness of the LC layer is 1.5 μm depending on selection of materials and the operating voltage.

### SUMMARY OF TE INVENTION

It is therefore an object of the present invention to solve the above-described problem by providing an LCD device which is capable of suppressing the cell gap irregularity between the liquid crystal injection hole and the vicinity thereof and sufficiently curing the UV-curable resin, to thereby suppress deterioration of the image quality in the vicinity of the injection hole.

The present invention provides a liquid crystal display (LCD) device including: a pair of transparent substrates; a seal resin stripe for bonding together the transparent substrates for encapsulating a liquid crystal layer between the transparent substrates; an UV-cured resin for sealing a liquid crystal injection hole formed in the seal resin stripe; and a dummy wire disposed in the injection hole between the UV-cured resin and one of the transparent substrates and having therein an opening for passing therethrough light.

The LCD device according to the present invention has a dummy wire arranged in the injection hole, and can suppress the cell gap irregularity between the injection hole and the vicinity of the injection hole. Having therein the dummy wire portion provided with opening in the injection hole, a sufficient amount of UV-rays can reach the inner side of the injection hole through the transparent substrates and the opening of the dummy wire. Accordingly, cell gap irregularity is suppressed and the UV-curable resin can be sufficiently cured, whereby deterioration of the image quality in the vicinity of the injection hole can be suppressed.

### BRIEF DESCRIPTION OF THE DRAWINGS

FIG. 1 is a top plan view of an LCD device according to an embodiment of the present invention;

FIG. 2 is a sectional view of the LCD device, taken along a line a-a′ shown in FIG. 1;

FIG. 3 is an enlarged partial top plan view of the vicinity of the injection hole shown in FIG. 1;

FIG. 4 is a sectional view of the injection hole, taken along a line b-b′ shown in FIG. 3;

FIG. 5 is a sectional view of the vicinity of the injection hole, taken along a line c-c′ shown in FIG. 3;

FIG. 6 is a sectional view of an LCD device of a first modification modified from the above embodiment, which corresponds to the structure shown in FIG. 4; and

FIGS. 7A and 7B show the shapes of second dummy wire portion in LCD devices of first and second modifications, respectively, modified from the above embodiment.

### DETAILED DESCRIPTION OF THE PREFERRED EMBODIMENTS

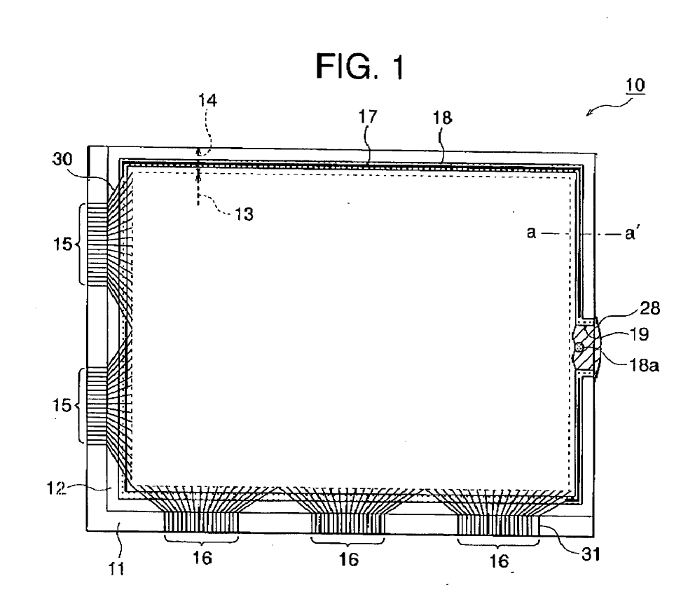

The present invention will further be described below based on an embodiment of the present invention with reference to the accompanying drawings. FIG. 1 shows a top plan view of an LCD device of active matrix drive type, generally designated by numeral 10.

The exemplified LCD device includes an array of pixels each including therein a reverse-staggered TFT (thin film transistor). In FIG. 1, the LCD device 10 is shown as viewed from the front surface thereof. The LCD device 10 includes a TFT substrate 11 arranged on the rear side thereof, and a CF (color-filter) substrate 12 arranged on the display surface (front) side thereof, the CF substrate having dimensions slightly smaller as compared to the dimensions of the TFT substrate 11. The front surface of the LCD device 10 includes a display area 13 for displaying images, and a non-display area 14 located at the periphery of the display area 13.

On the TFT substrate 11, gate lines (scanning lines) 15 extend from one side edge of the non-display area 14 toward the display area 13, whereas drain lines (data lines) 16 extend from the bottom edge of the non-display area 14 toward the display area 13. Common lines 30 and 31 are arranged adjacent to the gate lines 15 and the drain lines 16.

The gate lines 15 and the drain lines 16 are connected to TFTs of pixels (not shown) arranged in a matrix on the display area 13 of the TFT substrate 11. The gate lines 15 and the associated common wire 30 are connected to scanning-line drivers (not shown) disposed at one side edge of the TFT substrate 11, whereas the drain lines 16 and the associated common wire 31 are connected to data-line drivers (not shown) at the bottom edge of the TFT substrate 11. On the TFT substrate 11, at the top edge and at the other side edge of the non-display area 14, including the vicinity of an injection hole 19, a dummy wire (seal-member dummy wire) 17 is provided. The dummy wire 17 includes a pair of first portions (17b) outside the injection hole 18 and a second portion (17a) inside the injection hole 19 as will be detailed later, and is connected to the common lines 30, 31.

A seal resin stripe 18 is disposed on the non-display area 14 between the TFT substrate 11 and the CF substrate 12, excluding the injection hole 19, the seal resin stripe 18 surrounding the display area 13. The seal resin stripe 18 is made of epoxy resin, and is approximately 1 mm wide. At the top edge and the other side edge of the non-display area 14, where the gate lines 15 and the drain lines 16 do not extend, the seal resin stripe 18 is so arranged as to overlap the first portion of the dummy wire 17. The distance between the seal resin stripe 18 and the display area 13 is approximately 10 mm.

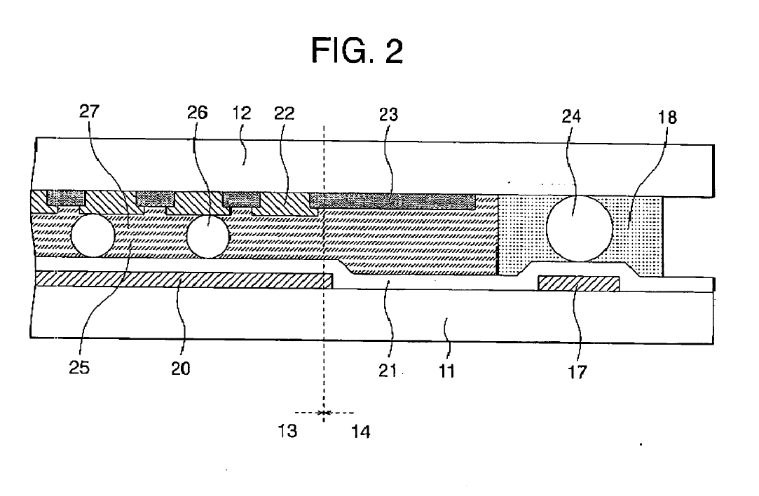

FIG. 2 is a sectional view of the LCD device 10, taken along line a-a′ shown in FIG. 1. The TFT substrate 11 is approximately 700 μm thick. The TFT substrate 11, corresponding to the display area 13 and part of the non-display area 14, has thereon a TFT array unit 20 being approximately 1.3 μm in thickness. The TFT array unit 20 has thereon pixel electrodes, TFT elements connected to the pixel electrodes to drive the pixel electrodes, and gate lines and drain lines to drive the TFT elements. In this way, on the portion of the TFT substrate 11 corresponding to the display area 13, the gate lines 15 and the drain lines 16 are so arranged as to form a matrix, and the TFT elements and the pixel electrodes are arranged at the intersections of thus formed matrix. The structure on the TFT substrate 11 corresponding to the display area 13 is referred to as the TFT array unit 20.

The dummy wire 17 and the gate lines 15, not shown, are formed during a common process, and are approximately 0.33 μm thick. The drain lines 16, not shown, are approximately 0.21 μm thick. The gate lines 15, drain lines 16, and dummy wire 17 is made of, for example, aluminum. On the other hand, material of the gate lines 15 and drain lines 16 is not restricted to aluminum, and may be other metallic material. Generally, pure metal such as aluminum, chromium, molybdenum, or alloyed metal thereof, or layered films thereof can be used.

On the TFT substrate 11 as well as on the TFT array unit 20, gate lines 15, drain lines 16, and dummy wire 17 which are arranged on the TFT substrate 11, an insulating film 21 is formed. The insulating film 21 is made of inorganic material such as silicon nitride, silicon oxide, etc. and is approximately 0.3 μm thick.

The CF substrate 12 is approximately 700 μm thick. The CF substrate 12, corresponding to the display area 13, has thereon color layers 22 each having an approximate thickness of 2 μm. The color layers 22 includes an R layer of red color, a G layer of green color, and a B layer of blue color. A light-shielding layer (black matrix layer) 23 made of resin material is arranged on the area where the color layers 22 are not arranged. The light-shielding layer 23 is approximately 1.3 μm thick.

The seal resin stripe 18 is arranged between the insulating film 21 arranged on the TFT substrate 11 and the CF substrate 12. The seal resin stripe 18 has therein a cylindrical seal member spacer 24 made of glass being 5 μm in diameter. The seal member spacer 24 has its side portion in contact with the insulating film 21, while has its opposite side portion in contact with the CF substrate 12, which maintains the distance between the insulating film 21 and the CF substrate 12 at a constant. The seal resin stripe 18 can be formed on the TFT substrate 11 having thereon the insulating film 21 by screen printing.

Liquid crystal 27 is encapsulated in a liquid crystal encapsulation space 25 that is formed between the TFT substrate 11 and the CF substrate 12 and enclosed by the seal resin stripe 18. The liquid crystal 27 has therein spherical liquid crystal spacers 26 made of polymer (organic cross-linked polymer particles) being 3 μm in diameter. The diameter difference of 2 μm between the liquid crystal spacer 26 and the seal member spacer 24 is equal to the thickness of the color layer 22. Being distributed in the liquid crystal encapsulation space 25 in advance at the time the TFT substrate 11 and the CF substrate 12 are bonded together by means of the seal resin stripe 18, the liquid crystal spacers 26 are encapsulated in the liquid crystal encapsulation space 25. The liquid crystal spacers 26 have their rear portions in contact with the insulating film 21, while have their front portions in contact with the color layer 22, whereby the liquid crystal spacers 26 maintains the distance between the insulating film 21 and the color layer 22 at a constant. Other than polymer, the liquid crystal spacers 26 may be made of inorganic particles, or organic-inorganic complex particles.

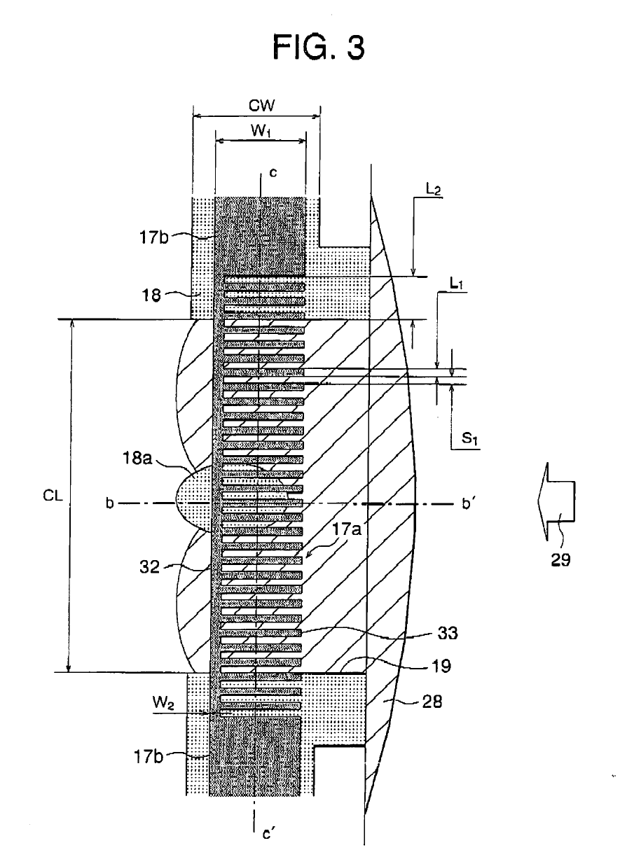

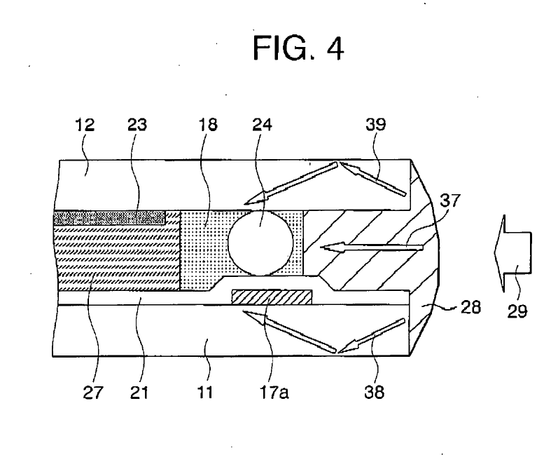

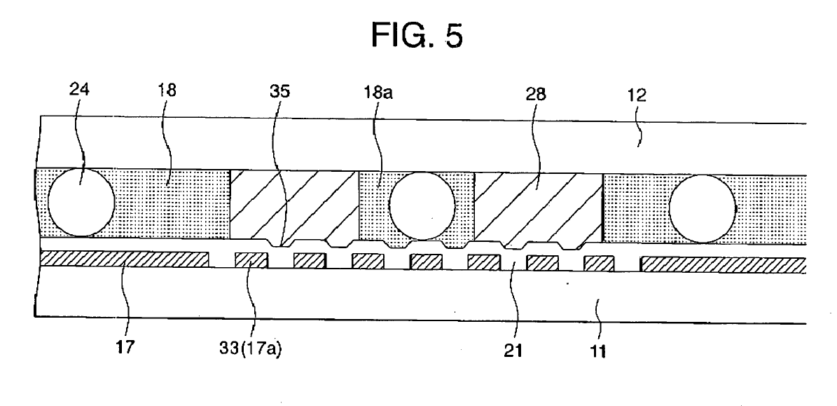

FIG. 3 shows an enlarged view of the vicinity of the injection hole 19 shown in FIG. 1. FIG. 4 and FIG. 5 show sectional views of the injection hole 19 along lines b-b′ and c-c′ shown in FIG. 3. Width CW of the seal resin stripe 18 is 0.7 mm, and width CL of the injection hole 19 along the longitudinal direction is 16 mm. In the injection hole 19 as well as in the vicinity of the injection hole 19, the second portion 17a of the dummy wire 17 is sandwiched between the first portions 17E of the dummy wire 17. The second dummy wire portion 17a is in the shape of a comb, and are composed of a linear stripe 32 extending in parallel with the edges of the substrates, and a plurality of comb tooth sections 33 which extend from the linear stripe 32 toward the edge of the substrate. In FIG. 3, width W₁ of the dummy wire 17 (17a and 17b) is approximately 700 μm, whereas width W₂ of the linear stripe 32 is 10 μm, width L₁ of the comb tooth section 33 is 50 μm, and clearance S₁ between the comb tooth sections 33 is 50 μm. On the other hand, in FIG. 3, dimension L₂ of protrusion of the second portion 17a from the injection hole 19 is approximately 4 mm. The width CL of the injection hole 19 may be designed 15 to 20 mm.

In the injection hole 19, three cylindrical buffering seal members 18a are arranged along the direction parallel to the edge of the substrate, although only one buffering seal member 18a is shown in FIG. 3. The three buffering seal members 18a are of an ellipse of 0.6 mm in diameter along the direction parallel to the edge of the LCD panel and of 1.4 mm in diameter along the direction normal thereto, as viewed from the front surface of the LCD device. The buffering seal members 18a configure part of the seal resin stripe 18, and have therein a cylindrical seal member spacer 24 of 5 μm in diameter, as shown in FIG. 4 and FIG. 5. The buffering seal members 18a are so arranged as to overlap the second dummy wire portion 17a, and somewhat protrude from the seal resin stripe 18 toward the display area 13. The buffering seal members 18a can be formed by a screen printing technique during the process of forming the seal resin stripe 18. The number of the buffering seal members 18a is not restricted to three, and one or several buffering seal members 18a cm be arranged. A large-size LCD device has a larger width CL of the injection hole 19, and thus a larger number of buffering seal members 18a may be used.

If the width L₁ of the comb tooth section 33 is too small, or the clearance S₁ between the comb tooth sections 33 is too large, the cylindrical seal member spacer 24 cannot be held between the insulating film 21 arranged on the comb tooth sections 33 and the CF substrate 12. In this case, the thickness of the buffering seal members 18a is made small, which cannot suppress cell gap irregularity between the injection hole 19 and the vicinity of the injection hole 19. According to the present embodiment, by setting the width L₁ of the comb tooth section 33 to be 50 μm and setting the clearance S₁ to be 50 μm, the seal member spacer 24 can be securely held between the insulating film 21 arranged on the comb tooth sections 33 and the CF substrate 12, which can keep the thickness of the buffering seal members 18a at a predetermined value.

Furthermore, since the comb tooth sections 33 are formed perpendicularly to the edges of the substrates, grooves 35 are formed on the surface of the insulating film 21 along the direction of injecting the liquid crystal 27, as shown in FIG. 5. The liquid crystal 27 can be smoothly and fluently injected due to these grooves 35. Since the linear stripe 32 has its both ends extending from the ends of the first portions 17b of the dummy wire 17, the second dummy wire portion 17a is maintained at the common potential.

The injection hole 19 is sealed by UV-curable resin 28, and the UV-curable resin 28 works as a hole-sealing member for sealing the liquid crystal 27 within the liquid crystal encapsulation space 25. In order to securely seal the liquid crystal 27 therein, the UV-curable resin 28 should be injected to pass the edges of the seal resin stripe 18 and the buffering seal members 18a near the display area 13.

In FIG. 4, when ultraviolet rays 29 are incident onto the injection hole 19 in the direction parallel to the substrate surface and normal to the edge of the substrate, the UV-curable resin 28 is cured from the outward portion to the inner portion of the UV-curable resin 28. Since ultraviolet rays are absorbed by UV-curable resin 28, ultraviolet rays 37 penetrating through the injection hole 19 may have difficulty in reaching the inner portion of the UV-curable resin 28 located at the inner side of the injection hole 19. Especially, in the case of the LCD device 10 of the present embodiment wherein the thickness of the buffering seal members 18a is only approximately 5 μm, whereby this phenomenon may be considered crucial.

However, according to the LCD device 10 of the present embodiment, the structure wherein the second dummy wire portion 17a is provided with gaps or clearances (S1) between the comb toot sections 33 allows part of ultraviolet rays 38 to penetrate toward the inside of the transparent PTT substrate 11. This reason is as follows. In FIG. 4, the UV-rays 29 incident onto the UV-curable resin 28 also enters the TFT substrate 11 and the CF substrate 12 from the edges thereof in the direction substantially parallel to the substrate surfaces.

The UV-rays 29 incident onto the substrates 11 and 12 travels within the substrates 11 and 12 and some of them are reflected on the outer surfaces of the substrates to enter the UV-curable resin 28 after passing through the inner surfaces of the substrates 11 and 12. The UV-rays 29 passed the inner surface of the TFT substrate 11 pass the clearances of the second dummy wire portion 33 to enter the UV-curable resin 28 for curing thereof. In addition, since the CF substrate 12 does not have light-shielding property, some of ultraviolet rays 39 advance toward the inside of the transparent CF substrate 12 with the traveling directions thereof deflected, and enters into the injection hole 19 to cure the UV-curable resin 28. Accordingly, a sufficient amount of ultraviolet rays 29 can be irradiated to the UV-curable resin 28 located at the inner side of the injection hole 19, which can securely cure the WV-curable resin 28 inside the injection hole 19.

According to the LCD device 10 of the present embodiment, due to the dummy wire 17 thus provided, it is possible to maintain an excellent image quality by adjusting the thickness of the edges of the LCD device 10. Furthermore, since the second dummy wire portion 17a is arranged in the injection hole 19, cell gap irregularity between the injection hole 19 and the vicinity of the injection hole 19 can be suppressed. Furthermore, due to the second dummy wire portion 17a in the form of a comb provided with clearances, a sufficient amount of ultraviolet rays can be allowed to reach the inner side of the injection hole 19 through the TFT substrate 11. Accordingly, cell gap irregularity is suppressed and the UV-curable resin 28 can be sufficiently cured, whereby deterioration of image quality in the vicinity of the injection hole 19 can be lowered.

According to experimental tests of the LCD device 10 of the present embodiment, when pitch of the comb tooth sections 33, or the L₁+S₁, is set to be within 10 μm to 1000 μm, and the ratio between the width L₁ and the clearance S₁ of the comb tooth sections 32 is set to be within 8:2 to 3:7, sufficient and uniform ultraviolet rays can be incident onto the portion of the UV-curable resin 28 located at the inner side of the injection hole 19, and the thickness of the buffering seal members 18a can be kept at a predetermined value.

A larger thickness of the color layer 22 provides a deeper chromaticity. In case of an R layer, for example, red assumes a deeper red color. Accordingly, when the color layer 22 is made thick, the color reproducibility or reproducible color range can be made broad. The color layer 22 of the present embodiment, having a thickness of 2 μm, is the thickest layer among the currently available LCD device, and can realize color reproducibility of EBU (European Broadcasting Union) standard. On the other hand, if the thickness of the color layer 22 is larger, the thickness of the LC layer is reduced accordingly.

Thus, it is considered that the image quality of the LCD device is easily affected by the cell gap irregularity in the vicinity of the injection hole 19. Therefore, the advantage of the present invention is considered larger in the case of such a LCD device having a smaller thickness. It is noted here that the thickness of a color layer of LCD devices used in general notebook-size PC, PC monitors, etc. is approximately 1.2 μm to 1.7 μm.

According to the present embodiment, since the entire dummy wire 17 including the second dummy wire portion 17a is maintained at the common potential, damage of insulating films due to electric discharge caused in the manufacturing process is suppressed, which can improve the product yield thereof. During the operation, if a high DC voltage were applied to the second dummy wire portion 17a, significant unevenness in the image display may be raised, which may lower reliability of the LCD device. However, since the common potential at which the second dummy wire portion 17a of the present embodiment is maintained is close to the spatial and temporal average potential within the LCD device 10, unevenness in the image display on the LCD device can be suppressed, which can improve reliability of the LCD device 10. Although the second dummy wire portion 17a is preferably maintained at the common potential, the second dummy wire portion 17a may be connected to the drain lines 16 or the gate lines 15. Even in this case, electric discharge can be suitably suppressed as compared with the conventional cases.

According to the present embodiment, the injection hole 19 is formed at one side edge of the non-display area 14. On the other hand, the injection hole 19 may be formed at the other side edge of the non-display area 14 where the gate lines 15 and the drain lines 16 are not arranged, Furthermore, in the embodiment, the insulating film 21 is arranged on the TFT array unit 20. On the other hand, the present invention can be employed irrespective of the layer configuration on the TFT substrate 11. For example, the present invention can be applied to an LCD device in which a TFT array unit is arranged on an insulating film, or an LCD device in which an organic insulating film having a thickness of approximately 0.8 μm to 2.0 μm and a TFT array unit are arranged on an insulating film. Furthermore, an organic insulating film having a thickness of approximately 1 μm may be arranged on the whole CF substrate 12, covering the color layer 22 and the light-shielding layer 23.

According to the present embodiment, the linear stripe 32 is in contact with the inner side of the comb tooth sections 33. On the other hand, the position where the linear stripe 32 is arranged is not restricted to this structure, and the linear stripe 32 of the second dummy wire portion 17a may be disposed in the middle portion or outer portion of the injection hole 19. In the embodiment, the dummy wire 17 is so arranged as to completely overlap the seal resin stripe 18. However, the dummy wire 17 is not necessarily required to be arranged in this way. The dummy wire 17 may be arranged in other ways so long as the seal member spacer 24 is held between the insulating film 21 arranged on the dummy wire 17 and the CF substrate 12.

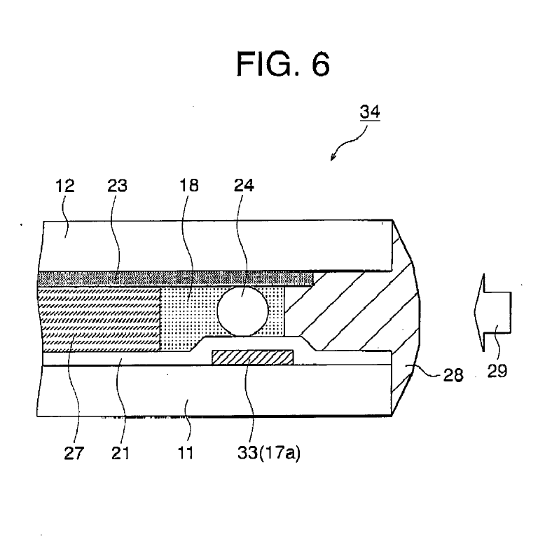

According to the present embodiment, the light-shielding layer 23 is made of resin material. On the other hand, the light-shielding layer 23 may be made of metal material as shown in the following first modification. FIG. 6 shows a partial sectional view of an LCD device of the first modification, corresponding to the structure shown in FIG. 4. According to the LCD device 34 of the first modification, the light-shielding layer 23 is made of chrome having a thickness of 0.14 μm, and is arranged on the seal resin stripe 18 and extends to the outside of the buffering seal members. The seal resin stripe 18 and the buffering seal members are arranged between the insulating film 21 and the light-shielding layer 23.

According to the fist modification, ultraviolet rays incident from the CF substrate 12 may be blocked by the light-shielding layer 23. However, ultraviolet rays incident from the edge of the TFT substrate 11 can be assured due to the second dummy wire portion 17a provided with clearances, which can sufficiently cure the UV-curable resin 28. In the first modification, since ultraviolet rays from the edge of the CF substrate 12 are blocked, it is desired that the clearance S₁ of the second dummy wire portion 17a be set to be broader as compared with the case of the embodiment so as to increase ultraviolet rays incident from the TFT substrate 11. The light-shielding layer 23 may be made of chrome oxide, metal multiple layers, etc. in addition to chrome.

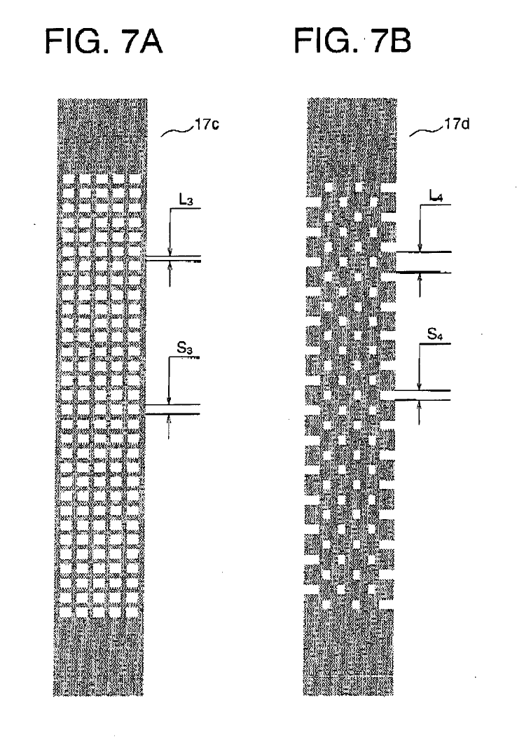

In the embodiment, the second dummy wire portion 17a in the shape of a comb is employed. However, second dummy wire portion of other shapes shown in second and third modifications can be employed. FIG. 7A shows the structure of the second dummy wire portion 17c in an LCD device according to the second modification. In the LCD device of the second modification, the second dummy wire portion 17c is formed in a latticed structure, in which uniformly-arranged longitudinal stripes and uniformly-arranged lateral stripes intersect with each other. In FIG. 7A, width L of each stripe of the lattice is 30 μm and clearance S₃ between the stripes is 70 μm, whereas the pitch (L₃+S₃) can be set to be within 10 μm to 1000 μm, and the ratio between the width L₃ and clearance S₃ can be set within 8:2 to 3:7.

FIG. 7B shows the structure of the second dummy wire portion 17d in an LCD device according to the third modification. In the LCD device of the third modification, the second dummy wire portion 17d is formed in a checkered structure, in which squares 36 are so arranged as to form a checkered pattern, as shown in FIG. 7B. Neighboring squares 36 are inter-connected to one other at the corners thereof, and are maintained at the common potential, In FIG. 7B, dimension L₄ of one side of the squares 36 is 60 μm and clearance S₄ is 40 μm, whereas the pitch (L₄+S₄) can be set within 10 μm to 1000 μm, and the ratio between the dimension L₄ and clearance S₄ can be set to be within 8:2 to 5:5.

The shape of the second dummy wire portion is not restricted to those described in the embodiment and the modifications, and may be a meshed shape or a plurality of stripes which extend in parallel with edges of the substrates.

While the invention has been described in accordance with preferred embodiments thereof illustrated in the accompanying drawings and described in the above description in detail, it should be understood by those ordinarily skilled in the art that the present invention is not limited to the embodiment or modifications, and various modifications, alternative constructions or equivalents can be implemented without departing from the scope and spirit of the present invention.

The LCD device according to the present invention can be applied to any of IPS (In-Plane Switching)-mode, TN (Twisted Nematic)-mode, VA (Vertically Aligned)-mode LCD devices using nematic liquid crystal.

1. A liquid crystal display (LCD) device comprising:
a pair of transparent substrates;
a seal resin stripe for bonding together said transparent substrates for encapsulating a liquid crystal layer between said transparent substrates;
an UV-cured resin for sealing a liquid crystal injection hole formed in said seal resin stripe; and
a dummy wire disposed in said injection hole between said UV-cured resin and one of said transparent substrates and having therein an opening for passing therethrough light.

2. The LCD device according to claim 1, wherein said seal resin stripe receives therein a plurality of spacers for defining a gap between said transparent substrates.

3. The LCD device according to claim 1, wherein said dummy wire is of a comb shape including a linear section extending parallel to an edge of said one of said transparent substrates and a plurality of comb tooth sections extending from said linear section perpendicular thereto.

4. The LCD device according to claim 1, wherein said dummy wire is of a lattice structure.

5. The LCD device according to claim 1, wherein said dummy wire is of a checkered pattern.

6. The LCD device according to claim 1, wherein said dummy wire has another portion other than the portion disposed in said injection hole, and said another portion is disposed between said seal dummy stripe and said one of said transparent substrates.

7. The LCD device according to claim 6, wherein said dummy wire is made of a conductive material.

8. The LCD device according to claim 7, wherein said dummy wire is connected to a common line formed on said one of said transparent substrates.

9. The LCD device according to claim 1, wherein said dummy wire is formed as a common layer with gate lines formed on said one of said transparent substrates.

10. The LCD device according to claim 1, wherein said liquid crystal layer has a thickness of 1.5 to 4.0 μm.

11. The LCD device according to claim 1, wherein said injection hole receives therein a buffering seal resin member made of a material same as a material of said seal resin stripe, and said buffering seal resin member is in contact with said dummy wire.
